(19) United States
(12) Patent Application Publication
(10) Pub. No.: US 2003/0231567 A1
(43) Pub. Date: Dec. 18, 2003

(54) Hybrid recording medium and information recording and reproduction apparatuses therefor

(76) Inventor: Ichiro Moritomo, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/436,073

(22) Filed: May 13, 2003

(30) Foreign Application Priority Data
Jun. 14, 2002 (JP) 2002-173905

(51) Int. Cl. G11B 7/00

(52) U.S. Cl. 369/53.21; 369/275.3; 369/53.22

(57) ABSTRACT

An information recording medium includes a pre-stamped region formed by pre-stamping a region from the start of the data region of the information recording medium. The pre-stamped region records information indicating that the information recording medium is a hybrid recording medium formed of a recorded region and an unrecorded region and information indicating that a sector in the pre-stamped region is pre-stamped. The information recording medium is formed based on a recordable recording medium.

### BACKGROUND OF THE INVENTION

1. Field of the Invention

The present invention generally relates to the information recording and reproduction of a hybrid recording medium having a recorded region in which an application program is recorded in advance and an unrecorded region, and more particularly to a hybrid recording medium of, for instance, a DVD+RW disk, an information recording apparatus and method for recording information on the hybrid recording medium, and an information reproduction apparatus for reproducing information recorded on the hybrid recording medium.

2. Description of the Related Art

Recently, optical disk recording media, which are portable and have a large capacity, have been widely used as information recording media for personal computers (PCs).

Typical optical disk recording media include recordable ones such as CD−R, DVD−R, and DVD+R disks and rewritable ones such as CD−RW, DVD−RW, and DVD+RW disks. Further, CD-ROM and DVD-ROM disks are widely used as read-only optical disk recording media.

Some of such optical disk recording media are hybrid recording media composed of a recorded region and an unrecorded region. An application program is recorded in advance in the recorded region at the time of shipment. A user can freely write data to the unrecorded region after the shipment as a work region for the application program recorded in the recorded region. Japanese Laid-Open Patent Application No. 6-349248 discloses such a hybrid recording medium. Further, the hybrid recording medium is defined in Part II and Part III of the so-called Orange Book, a document describing optical disk specifications, written by the Sony and Philips Corporations.

In the case of using a hybrid recording medium, an information recording and reproduction apparatus for recording information on or reproducing information from the hybrid recording medium, such as a CD−R/RW drive or a DVD−R/RAM/RW drive, is connected to a PC. When the hybrid recording medium is inserted into the information recording and reproduction apparatus, an application program stored in the recorded region of the hybrid recording medium is automatically read to be activated and executed on the PC. The unrecorded region of the hybrid recording medium is used to retain or store data in the processing of the application program.

For reasons concerning the manufacturing method of optical disk recording media, in the case of manufacturing a hybrid recording medium using a DVD+RW disk, as in the case of using a CD−RW disk, the unrecorded region is formed preserving the DVD+RW specifications as they are while the recorded region is formed at the time of shipment by forming new pits in the grooves based on the structure of the DVD+RW disk. This method is employed so as to minimize the production cost.

In the case of such type of hybrid recording medium, for instance, a DVD+RW hybrid recording medium, multi-session recording is not specified in the DVD+RW standard, so that in the case of additional recording, the additional recording is performed by erasing the lead-out region after the data region.

Further, in order that an information recording and reproduction apparatus supporting conventional DVD+RW disks can reproduce information from the DVD+RW hybrid recording medium manufactured by the above-described method, not only the data region but also the lead-in region and the lead-out region should be preserved as formatted at the time of shipment.

In the case of the conventional DVD+RW hybrid recording medium manufactured by the above-described method, however, there is a problem that the data of the lead-out region is recorded as unnecessary data to be overwritten in recording additional data.

On the other hand, it has been proposed to form the lead-in region and the lead-out region as well as the data region using a stamper as pre-stamped lead-in and lead-out regions, respectively.

### SUMMARY OF THE INVENTION

In the case of the above-described conventional hybrid recording medium, however, additional data recording requires rewriting the pre-stamped lead-in region and erasing the pre-stamped lead-out region, which destroys the data in the pre-stamped part so that the recording medium itself becomes unusable. Alternatively, the hybrid recording medium may be manufactured by recording the lead-in and lead-out regions as well as the data region using an information recording and reproduction apparatus. However, this method, which may be called “prerecording” in contrast to “pre-stamping,” incurs an increase in the production cost.

Accordingly, it is a general object of the present invention to provide a hybrid recording medium and an information recording apparatus and method for recording information on the hybrid recording medium in which the above-described disadvantages are eliminated.

A more specific object of the present invention is to provide a hybrid information recording medium composed of an unrewritable recorded region and a rewritable unrecorded region both formed by pre-stamping, and an information recording apparatus and method for recording information on the hybrid information recording medium that can inhibit writing to the recorded region of the hybrid information recording medium and can normally record information in the rewritable unrecorded region of the hybrid information recording medium.

Another more specific object of the present invention is to provide an information reproduction apparatus that can normally reproduce recorded information from the hybrid information recording medium.

Yet another more specific object of the present invention is to provide a program causing a computer to execute the information recording method and a computer-readable recording medium storing the program.

The above objects of the present invention are achieved by an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating that a sector in the pre-stamped region is pre-stamped, the information recording medium being formed based on a recordable recording medium.

The above objects of the present invention are also achieved by an information reproduction apparatus including a part that, in the case of detecting from an information recording medium identifier information indicating that the information recording medium is a hybrid recording medium formed of a recorded region and an unrecorded region, recognizes that the information recording medium is the hybrid recording medium and authorizes data reproduction from the information recording medium, wherein the information recording medium includes a pre-stamped region formed by pre-stamping a region from a start of a data region of the information recording medium, the pre-stamped region recording the identifier information and information indicating that a sector in the pre-stamped region is pre-stamped, the information recording medium recording lead-in information corresponding to data of the pre-stamped region, the lead-in information having at least part thereof prerecorded, the information recording medium being formed based on a recordable recording medium.

The above objects of the present invention are also achieved by an apparatus for reproducing information from an information recording medium, the apparatus including: a determination part that determines whether the information recording medium is a hybrid recording medium formed of a recorded region and a recordable unrecorded region; and an authorization part that authorizes data reproduction from the information recording medium when the determination part determines that the information recording medium is the hybrid recording medium.

The above objects of the present invention are also achieved by an information recording apparatus including a part that, in the case of detecting from an information recording medium identifier information indicating that the information recording medium is a hybrid recording medium formed of a recorded region and an unrecorded region, recognizes that the information recording medium is the hybrid recording medium, and when a command to perform writing to a sector in a pre-stamped region of the information recording medium is issued, reports to an issuer of the command that the writing to the sector in the pre-stamped region is prohibited and inhibits the writing to the information recording medium, wherein the pre-stamped region of the information recording medium is formed by pre-stamping a region from a start of a data region of the information recording medium, the pre-stamped region recording the identifier information and information indicating that the sector in the pre-stamped region is pre-stamped, the information recording medium recording lead-in information corresponding to data of the pre-stamped region, the lead-in information having at least part thereof prerecorded, the information recording medium being formed based on a recordable recording medium.

The above objects of the present invention are also achieved by an apparatus for recording information on an information recording medium, the apparatus including: a determination part that determines whether the information recording medium is a hybrid recording medium formed of a recorded region and a recordable unrecorded region; and a writing inhibition part that, when the determination part determines that the information recording medium is the hybrid recording medium, inhibits writing to a sector of a pre-stamped region of the information recording medium in response to a command to perform the writing to the sector of the pre-stamped region, the writing inhibition part reporting to an issuer of the command that the writing to the sector of the pre-stamped region is prohibited.

The above objects of the present invention are also achieved by an information reproduction apparatus including a part that, when an information recording medium formed of an unrecorded region and a recorded region formed by pre-stamping a region from a data region of the information recording medium is loaded, determines the presence or absence of a lead-in region of the information recording medium, determines the presence or absence of a data region in the absence of the lead-in region, and authorizes data reading from the information recording medium when data is recorded in the data region, the information recording medium being formed based on a recordable recording medium.

The above objects of the present invention are also achieved by an apparatus for reproducing information from an information recording medium, the apparatus including: a determination part that determines the presence or absence of a lead-in region on the information recording medium, determines the presence or absence of a data region in the absence of the lead-in region, and determines whether data is recorded in the data region when the presence of the data region is determined; and an authorization part that authorizes data reading from the information recording medium when the determination part determines that the data is recorded in the data region.

The above objects of the present invention are also achieved by an information recording apparatus including a part that, when an information recording medium formed of an unrecorded region and a recorded region formed by pre-stamping a region from a data region of the information recording medium is loaded, determines the presence or absence of a lead-in region of the information recording medium, and records data on the information recording medium based on a write enable command received from a host apparatus in the absence of the lead-in region, the information recording medium being formed based on a recordable recording medium.

The above objects of the present invention are also achieved by an apparatus for recording information on an information recording medium, the apparatus including: a determination part that determines the presence or absence of a lead-in region on the information recording medium; and a recording part that records data on the information recording medium based on a write enable command in the absence of the lead-in region.

The above objects of the present invention are also achieved by an information recording method including the steps of: (a) issuing a write enable command; (b) recording information on an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating a sector in the pre-stamped region is pre-stamped, the information recording medium being formed based on a recordable recording medium; and (c) recording a lead-in region and a lead-out region on the information recording medium.

The above objects of the present invention are also achieved by a program for causing a computer to execute an information recording method, the information recording method including the steps of: (a) issuing a write enable command; (b) recording information on an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating a sector in the pre-stamped region is pre-stamped, the information recording medium being formed based on a recordable recording medium; and (c) recording a lead-in region and a lead-out region on the information recording medium.

The above objects of the present invention are further achieved by a computer-readable recording medium storing a program for causing a computer to execute an information recording method, the information recording method including the steps of: (a) issuing a write enable command; (b) recording information on an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating a sector in the pre-stamped region is pre-stamped, the information recording medium being formed based on a recordable recording medium; and (c) recording a lead-in region and a lead-out region on the information recording medium.

According to the above-described information recording medium, writing to the recorded region of the information recording medium can be inhibited.

Further, according to the above-described information reproduction apparatuses, information can be reproduced normally from such an information recording medium.

Further, according to the above-described information recording apparatuses and method, information can be recorded normally on such an information recording medium.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing an optical disk drive that is an information reproduction apparatus and an information recording apparatus according to a first embodiment of the present invention;

FIG. 2 is a block diagram showing a configuration of a PC system using the optical disk drive of FIG. 1 according to the first embodiment of the present invention;

FIG. 3 is a diagram showing an internal format of a program storage part of FIG. 2 according to the first embodiment of the present invention;

FIG. 4 is a diagram showing a configuration of a DVD+RW disk, which is an example of an optical disk according to the first embodiment of the present invention;

FIG. 5 is a diagram showing a data layout of the DVD+RW disk of FIG. 4 according to the first embodiment of the present invention;

FIG. 6 is a flowchart of the operation of a conventional disk drive in the case where an optical disk is loaded thereinto;

FIG. 7 is a flowchart of an operation of an optical disk drive according to the second embodiment of the present invention; and

FIG. 8 is another flowchart of the operation of the optical disk drive according to the second embodiment of the present invention.

### DETAILED DESCRIPTION OF THE PREFERRED EMBODIMENTS

A description will now be given, with reference to the accompanying drawings, of embodiments of the present invention.

In the specification, a “pre-stamped” region on a recording medium refers to a region in which embossed marks or pits are preformed by a stamper so that predetermined data is recorded inerasably. On the other hand, “prerecording” refers to recording data in advance by an information recording apparatus so that the data can be overwritten.

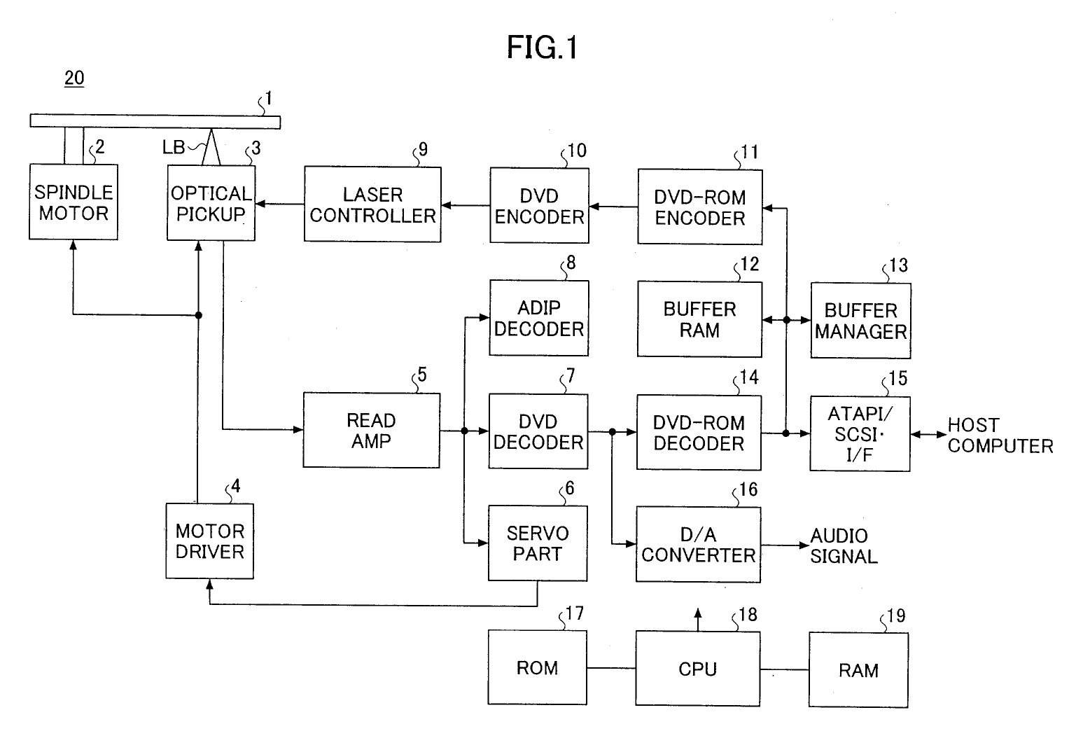

FIG. 1 is a block diagram showing an optical disk drive 20 that is an information reproduction apparatus and an information recording apparatus according to a first embodiment of the present invention.

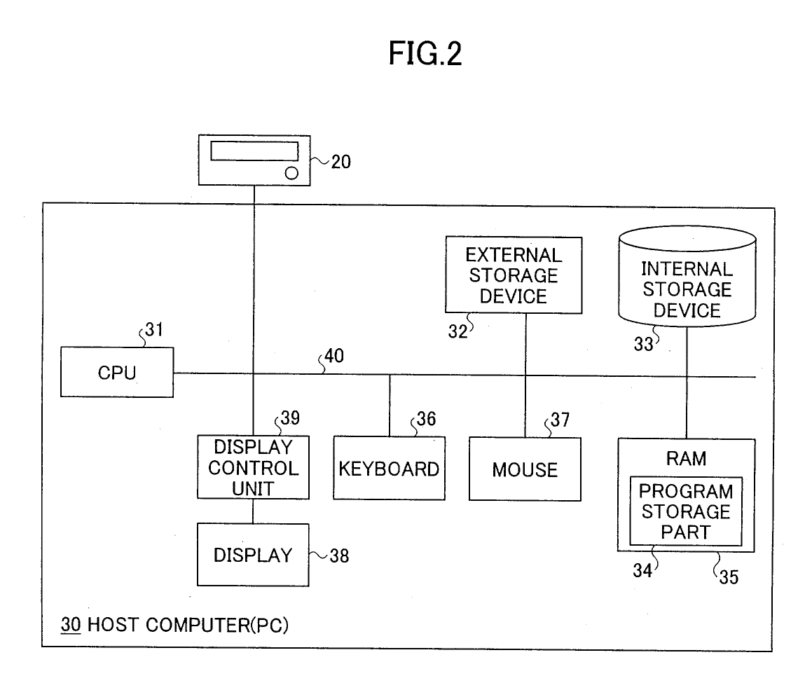

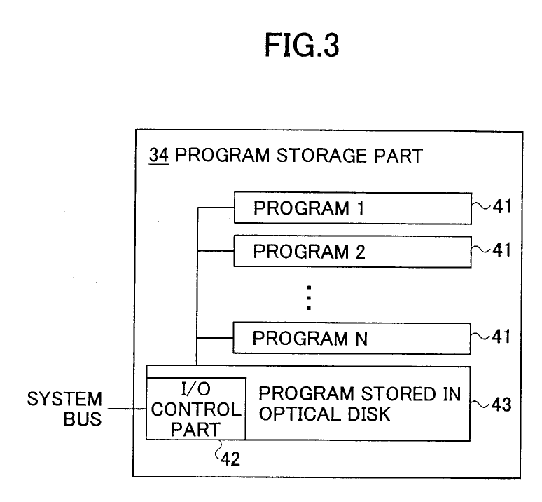

FIG. 2 is a block diagram showing a configuration of a PC system using the optical disk drive 20 of FIG. 1. FIG. 3 is a diagram showing an internal format of a program storage part 34 of FIG. 2.

As shown in FIG. 2, the PC system includes a host computer 30 and an optical disk drive 20. The host computer 30 includes a CPU 31, an external storage device 32, an internal storage device 33 such as an HDD, the program storage part 34 normally using part of a RAM 35, the RAM 35, a keyboard 36, a mouse 37, a display 38, a display control unit 39, and a system bus 40.

The operating system stored in the internal storage device 33 is loaded into the RAM 35 so as to control the entire system. Normally, when an application program is activated, the application program is similarly loaded into the program storage part 34 to which the RAM 35 is allocated as shown in FIG. 3 so that operations are performed using the components of the PC system.

As shown in FIG. 3, the program storage part 34 stores a variety of programs 41 and an application program stored in an optical disk 1 attached to the optical disk drive 20. The application program 43 includes a program that realizes an I/O control part 42.

As shown in FIG. 1, the optical disk drive 20 includes the optical disk 1, a spindle motor 2, an optical pickup 3, a motor driver 4, a read amplifier 5, a servo part 6, a DVD decoder 7, an ADIP decoder 8, a laser controller 9, a DVD encoder 10, a DVD-ROM encoder 11, a buffer RAM 12, a buffer manager 13, a DVD−ROM decoder 14, an ATAPI/SCSI interface (I/F) 15, a D/A converter 16, a ROM 17, a CPU 18, and a RAM 19.

In FIG. 1, the arrows indicate the directions in which data mainly flow. Further, for the simplification of the drawing, the connections between the CPU 18, which controls each component (block) of the optical disk drive 20, and the blocks are not shown individually but represented by the bold arrow extending from the CPU 18.

The optical disk 1 is a recordable DVD (digital versatile disk) disk that may be selected from a group of DVD-RAM/WO, DVD−R, and DVD+R disks or a group of DVD-RAM, DVD−RW, and DVD+RW disks. The DVD-RAM/WO, DVD−R, and DVD+R disks of the former group are DVD disks to which writing can be performed only once (and therefore are called DVDs Write Once).

The DVD-RAM, DVD−RW, and DVD+RW disks of the latter group are DVD disks to which writing can be performed a plurality of times.

The ROM 17 stores a control program written in a code decodable by the CPU 18.

When the optical disk drive 20 is turned on, the control program is loaded into a main memory (not shown in the drawing). The CPU 18 records information on and reproduces information from the optical disk 1, controlling the operations of the above-described components in accordance with the control program, and performs a control operation according to the present invention. The CPU 18 temporarily stores the data required for the control operation in the RAM 19.

The optical disk 1 is rotated by the spindle motor 2. The spindle motor 2 is controlled through the motor driver 4 and the servo part 6 so that the optical disk 1 is rotated at a constant liner velocity or a constant angular velocity. The constant liner velocity or the constant angular velocity may be varied by degrees.

The optical pickup 3 contains a well-known semiconductor laser source, optical system, focus actuator, tracking actuator, light receiving element, and position sensor, which are not shown in the drawing. The optical pickup 3 emits a laser beam LB to the optical disk 1 for data recording or reproduction.

The optical pickup 3 is movable in the sledge directions (radial directions of the optical disk 1) by a seek motor. The focus actuator, the tracking actuator, and the seek motor are controlled through the motor driver 4 and the servo part 6 based on signals obtained from the light receiving element and the position sensor so that the spot of the laser beam LB is located at a target position on the optical disk 1.

At the time of reading (data reproduction), a reproduced signal obtained by the optical pickup 3 is amplified in the read amplifier 5 into binary data to be input to the DVD decoder 7. In the DVD decoder 7, the input binary data is subjected to eight-to-sixteen demodulation. Recording data (data to be recorded) is modulated in the unit of eight bits by eight-to-sixteen modulation so that each eight bits are converted to 16 bits. In this case, coupling bits are added so that the number of binary “1s” and the number of binary “0s” of the modulated data are equalized on average. This is referred to as “suppression of DC components,” and a variation in the slice level of the reproduced signal from which the DC components are eliminated is suppressed.

The data demodulated in the DVD decoder 7 is subjected to deinterleaving and error correction. Thereafter, the data is input to the DVD-ROM decoder 14 to be subjected to further error correction in order to increase the reliability of the data.

The data thus subjected to error correction twice is temporarily stored in the buffer RAM 12 by the buffer manager 13. When the stored data becomes complete as sector data, all the stored data is transferred via the I/F 15 to the host computer (host apparatus) 30. In the case of music data, the output data of the DVD decoder 7 is input to the D/A converter 16 to be output therefrom as an analog audio output signal AUDIO.

At the time of writing (data recording), data transmitted through the I/F 15 from the host computer 30 is temporarily stored in the buffer RAM 12 by the buffer manager 13. Thereafter, a writing operation is started. In this case, before the writing operation is started, the laser spot should be located at the writing start position at which the writing operation is started. In the case of DVD+RW and DVD+R disks, the writing start position is obtained by a wobble signal recorded on the optical disk 1 by the wobbling of the tracks.

In the case of DVD−RW and DVD−R disks, the writing start position is obtained from land pre-pits instead of a wobble signal. In the case of DVD-RAM and DVD-RAM/WO disks, the writing start position is obtained from pre-pits.

The wobble signal in the DVD+RW and DVD+R disks includes address information called ADIP (address in pre-groove). The ADIP information is extracted by the ADIP decoder 8.

A synchronization signal generated by the ADIP decoder 8 is input to the DVD encoder 10 so that data can be written to an accurate position on the optical disk 1. The data in the buffer RAM 12 is output to the DVD-ROM encoder 11 and the DVD encoder 10 so that an error correcting code is added to and interleaving is performed on the data. Thereafter, the data is recorded on the optical disk 1 via the laser controller 9 and the optical pickup 3. The address information may be obtained from the land pre-pits or pre-pits depending on the type of the optical disk 1.

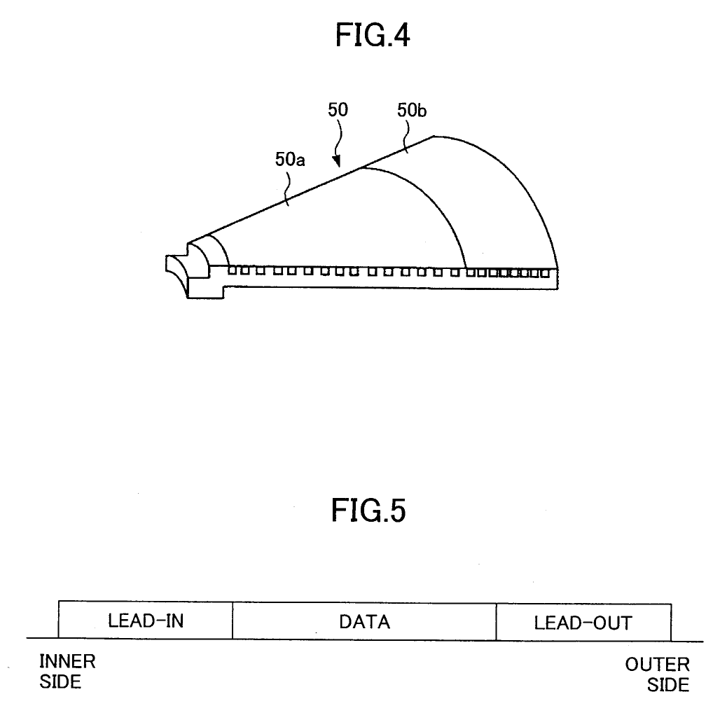

FIG. 4 is a diagram showing a configuration of a DVD+RW disk 50, which is an example of the optical disk 1 according to the present invention. FIG. 5 is a diagram showing a data layout of the DVD+RW disk of FIG. 4.

As shown in FIG. 4, the optical disk 50 is formed of a recorded region 50a and an unrecorded region (rewritable region) 50b. An application program and information according to the present invention are recorded by pre-stamping in the recorded region 50a at the time of the shipment of the optical disk 50. A user can freely write data to and rewrite data in the unrecorded region 50b after the shipment. According to the data layout shown in FIG. 5, a lead-in region, a data region, and a lead-out region are arranged on the optical disk 50 from the inner to the outer side.

In the pre-stamped recorded region 50a of the optical disk 50 shown in FIG. 4, “1100” is set in the bits 3 to 0 (b3-b0) of Disc Structure of Physical Format Information in ADIP specified in the DVD+RW standard book titled “DVD+RW 4.7 Gbytes Basic Format Specifications version 1.1 ” (in the case of a normal DVD+RW disk, “0100” is set). This data provides information indicating that the optical disk 50 is a hybrid recording medium formed of a recorded region and an unrecorded region. That is, this data serves as an identifier for the hybrid recording medium.

Further, in each pre-stamped sector of the recorded region 50a, the bit 25 (b25) of Sector Information of Identification Data also specified in the DVD+RW standard book is set to “ZERO” (in the case of a normal DVD+RW disk, the bit 25 is set to “ONE”). This data provides information indicating the sector is pre-stamped.

At this point, in the lead-in region, data is written to the Initial Zone, Inner Disc Test Zone, Inner Drive Test Zone, Guard Zone, Reserve Zone, Inner Disc Identification Zone, Reference Code Zone, Buffer Zone, and Control Data Zone also specified in the DVD+RW standard book. Data written to the Control Data Zone differs depending on the amount of data to be recorded based on the specification of Physical Format Information specified in the DVD+RW standard book. Therefore, the Control Data Zone should be rewritable.

Accordingly, at least the control data zone is formed by prerecording using a drive instead of pre-stamping at the time of shipment.

The zones of the lead-in region other than the control data zone may be formed by pre-stamping.

Further, the following data shown in TABLE 1, for instance, are recorded in Disc Manufacturing Information specified in the DVD+RW standard at the time of shipment.

TABLE 1

| Number of pre- | | |
|---|---|---|
| stamped regions | | |
| of data part | N | address |
| Pre-stamped | 1 | |
| region No. | | |
| Start address of | | *** |
| Region No. 1 | | |
| End address of | | *** |
| Region No. 1 | | |
| Pre-stamped | 2 | |
| region No. | | |
| Start address of | | *** |
| Region No. 2 | | |
| End address of | | *** |
| Region No. 2 | | |
| Pre-stamped | 3 | |
| region No. | | |
| Start address of | | *** |
| Region No. 3 | | |
| End address of | | *** |
| Region No. 3 | | |
| . . . | | |
| . . . | | |
| . . . | | |
| Pre-stamped | N | |
| region No. | | |
| Start address of | | *** |
| Region No. N | | |
| End address of | | *** |
| Region No. N | | |

When the optical disk 50 is loaded into the optical disk drive 20, the optical disk drive 20 can identify the pre-stamped regions in the recording region of the optical disk 50 based on the above-described information recorded on the optical disk 50.

In the case of forming a pre-stamped region on a rewritable recording medium by pre-stamping a continuous region as desired from the start of the data region, if only an end address is recorded by pre-stamping in the pre-stamped region, the optical disk drive 20 can identify the pre-stamped region in the recording region based on the end address on the optical disk 50.

Thus, a hybrid recording medium can be manufactured from a recordable (rewritable) recording medium with no multi-session specification by the above-described manufacturing method.

Next, a description will be given of data reproduction from the optical disk 50 recording the above-described information in the optical disk drive 20.

When the optical disk 50 recording the above-describe information is loaded into the optical disk drive 20 and the CPU 18 of the optical disk drive 20 detects the above-described information for identifying a hybrid recording medium in the recording region, the optical disk drive 20 recognizes the optical disk 50 not as an illegal medium but as a hybrid recording medium so as to authorize the host computer 30 to reproduce data from the optical disk 50.

Thus, when an information reproduction apparatus supporting data reproduction from a DVD+RW disk recognizes the loading of a hybrid DVD+RW disk recording medium, data can be read from the hybrid recording medium and a program thereon can be executed.

Next, a description will be given of data recording on the optical disk 50 recording the above-described information in the optical disk drive 20.

When the optical disk 50 recording the above-describe information is loaded into the optical disk drive 20 and the CPU 18 of the optical disk drive 20 detects the above-described information for identifying a hybrid recording medium in the recording region, the optical disk drive 20 recognizes the optical disk 50 as a hybrid recording medium. When a command to perform writing to a sector in the pre-stamped region of the optical disk 50 is issued from the host computer 30, the optical disk drive 20 transmits a message to the host computer 30, reporting that writing to the pre-stamped region is prohibited, and inhibits writing to the sector so that no data is written thereto.

Thus, the data of the pre-stamped region of the hybrid recording medium can be prevented from being damaged by overwriting.

Next, the Lead-out Zone specified in the above-described DVD+RW standard book may be recorded subsequent to a data part on the optical disk 50 as temporary lead-out information. The Lead-out Zone is formed of the Buffer Zone, Outer Disc Identification Zone, Guard Zone, Reserve Zone, Outer Drive Test Zone, and Outer Disc Test Zone.

Thereby, it is ensured that data is recorded after the end of the data part in reproducing data from the optical disk 50 in a reproduction-only DVD−ROM drive. Therefore, read error is prevented from occurring in reading the end part of the data part. Accordingly, no unrecorded part is detected even in the case of reproducing data and reading the end part of the data part in a reproduction-only DVD−ROM drive. Therefore, the data can be read from the optical disk 50 and a program thereon can be executed without any read error.

Next, a description will be given of a second embodiment of the present invention. An optical disk drive according to the second embodiment has the same configuration as the optical disk drive 20 of the first embodiment, but differs slightly therefrom in functions. Further, an optical disk according to the second embodiment is also different slightly from the optical disk 1 or 50 of the first embodiment. The optical disk according to the second embodiment is a rewritable recording medium and includes a pre-stamped region formed by pre-stamping a region from the start of the data region of the optical disk. The pre-stamped region records information indicating that the optical disk is a hybrid recording medium formed of a recorded region and an unrecorded region and information indicating that each sector in the pre-stamped region is pre-stamped. Further, neither lead-in region nor lead-out region is recorded, and an application program is recorded in advance in the data region.

The application program is a program for causing a computer to execute a method including the steps of: (a) issuing a write enable command that authorizes recording; (b) recording data on a recordable (rewritable) optical disk recording medium including a pre-stamped region formed by pre-stamping a region from the start of the data region of the recording medium, the pre-stamped region recording information indicating that the recording medium is a hybrid recording medium formed of a recorded region and an unrecorded region and information indicating that each sector of the pre-stamped region is pre-stamped; and (c) recording a lead-in region and a lead-out region on the recording medium.

According to the optical disk drive of the second embodiment, when a recordable (rewritable) optical disk formed of a recorded region and an unrecorded region formed by pre-stamping a region from the start of the data region of the optical disk is loaded into the optical disk drive, the CPU 18 determines whether the- optical disk includes a lead-in region. If the lead-in region is not included, the CPU 18 confirms the presence of the data region that follows the lead-in region. If data is recorded in the data region, the CPU 18 functions as a part authorizing the reading of data from the optical disk. Further, if the absence of the lead-in region is confirmed as a result of the above-described determination, the CPU 18 may also function as a part recording data on the optical disk based on a write enable command that authorizes recording received from a host computer (host apparatus).

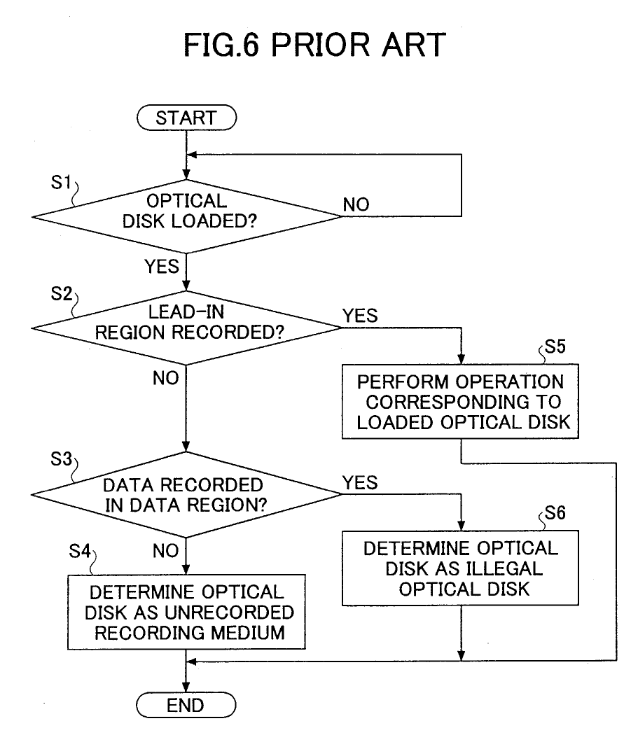

First, a description will be given of the operation of a conventional optical disk drive in the case where an optical disk is loaded into the optical disk drive in order to clarify the difference between the operation of the conventional optical disk drive and that of the optical disk drive according to the second embodiment. FIG. 6 is a flowchart of the operation of the conventional disk drive in the case where an optical disk is loaded thereinto.

According to this operation, first, in step S1, it is determined whether an optical disk is loaded. If an optical disk is loaded, in step S2, it is determined whether a lead-in region is recorded in the recording region of the optical disk. If a lead-in region is recorded, in step S5, an operation corresponding to the loaded optical disk is performed. For instance, when a normal DVD+RW disk is loaded, data recording or reproduction is performed in accordance with the normal DVD+RW disk.

On the other hand, if no lead-in region is recorded, in step S3, it is determined whether data is recorded in the data region of the optical disk. If data is recorded in the data region, in step S6, it is determined that the optical disk is illegal, and the operation is terminated. If no data is recorded in the data region, in step S4, it is determined that the optical disk is an unrecorded recording medium, and the operation is terminated.

Next, a description will be given of the operation of the optical disk drive of the second embodiment in the case where a hybrid optical disk recording medium that includes neither the lead-in region nor the lead-out region and has an application program recorded in advance in the data region is loaded into the optical disk drive.

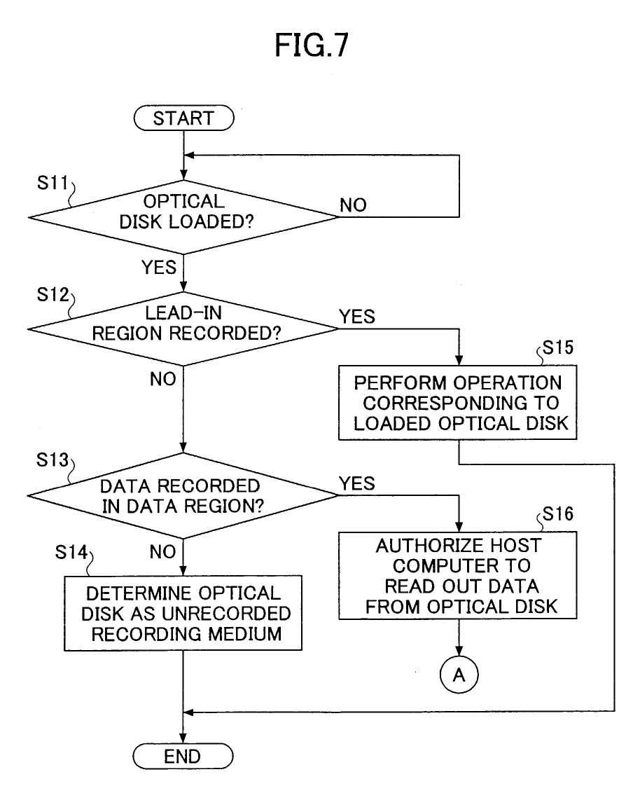

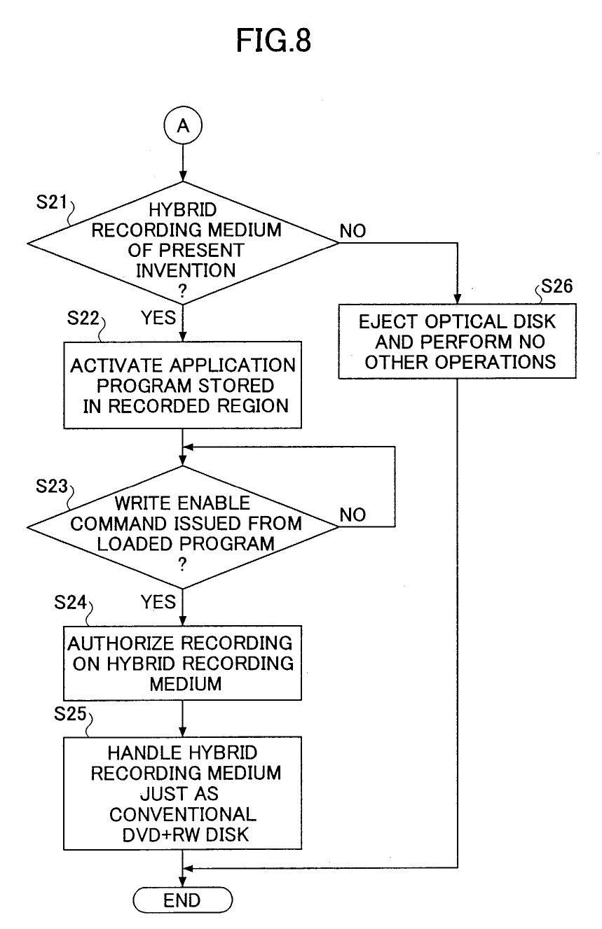

FIGS. 7 and 8 are flowcharts of the operation of the optical disk drive of the second embodiment in this case.

First, in step Sit of FIG. 7, the CPU 18 determines whether an optical disk is loaded into the optical disk drive. If an optical disk is loaded (“YES” in step S11), in step S12, the CPU 18 determines whether a lead-in region is recorded in the recording region of the optical disk. If a lead-in region is recorded (“YES” in step S12), in step S15, an operation corresponding to the loaded optical disk is performed. For instance, if a normal DVD+RW disk is loaded into the optical disk drive, data recording or reproduction is performed in accordance with the normal DVD+RW disk. On the other hand, if no lead-in region is recorded (“NO” in step S12), in step S13, the CPU 18 determines whether data is recorded in the data region that follows the lead-in region. If data is recorded in the data region (“YES” in step S13), in step S16, the CPU 18 determines that the optical disk may be a hybrid recording medium, and authorizes the host computer to read out data from the optical disk. If no data is recorded in the data region (“NO” in step S13), in step S14, the CPU 18 determines that the optical disk is an unrecorded recording medium, and terminates the operation.

After authorizing the reading of data from the optical disk, in step S21 of FIG. 8, the CPU 18 determines whether the optical disk is a hybrid recording medium according to the present invention. If the optical disk is not a hybrid recording medium according to the present invention (“NO” in step S21), in step S26, the host computer is not authorized to read out data from the optical disk and no operations other than the ejection of the optical disk are performed since the optical disk is an illegal disk. Then, the CPU 18 terminates the operation.

On the other hand, if the optical disk is a hybrid recording medium according to the present invention (“YES” in step S21), in step S22, the CPU 18 reads the application program stored in the data region of the recorded region of the optical disk into the program storage part of the host computer, and activates the application program. Then, in step S23, the CPU 18 determines whether a write enable command that authorizes recording on the optical disk is issued from the application program loaded into the program storage part. If a write enable command is issued from the application program (“YES” in step S23), in step S24, the CPU 18 authorizes the recording of data on the optical disk based on the write enable command received from the host computer. In step S25, the CPU 18 handles the optical disk in the same way as the conventional DVD+RW disk and allows data recording on the optical disk, regarding the optical disk as the hybrid recording medium according to the present invention.

As the basic operation of data recording, necessary data is written subsequent to already recorded data and the lead-in region and the lead-out region are recorded in accordance with instructions from the application program. The lead-in and lead-out regions are recorded on the optical disk in this state. Therefore, due to the characteristics of the DVD+RW disk, data can be read out from the optical disk in either the optical disk drive of the second embodiment or an optical disk drive with a DVD−ROM disk reading function.

Further, if there is still capacity in the unrecorded region of the optical disk, the lead-out region recorded at this point is temporary. Therefore, additional data can be recorded on the optical disk, overwriting the temporary lead-out region from its beginning, in either the optical disk drive of the second embodiment or an optical disk drive with a DVD+RW disk recording function.

Likewise, in the case of a DVD+R disk, additional data, the lead-in region, and the lead-out region can also be written to the disk in an optical disk drive with a DVD+R disk recording function, and data can be read out from the disk in an optical disk drive with a DVD+R disk reproduction function. The difference from the case of the DVD+RW disk lies in that the lead-in region and the lead-out region can be written only once to a DVD+R disk.

Variations of the application program recorded in the recorded region of the optical disk may include those realizing the functions of: using a space (unrecorded) area as a backup area by data backup software; recording a digital picture or a movie clip in a space (unrecorded) area by electronic album software; recording the latest catalog in a space (unrecorded) area by catalog browsing software; and using a space (unrecorded) area for on-line downloading of an upgrade version of a basic application recorded on the optical disk. The application program (including its variations) is stored in the recorded region of the optical disk at the time of shipment, and after the shipment, may employ the unrecorded region of the optical disk as a work area for the application program.

Thus, a hybrid recording medium can be manufactured from a recordable (rewritable) recording medium with no multi-session specification by the above-described manufacturing method.

Further, data can be read out from the hybrid recording medium and a program thereon can be executed.

Furthermore, necessary data can be additionally recorded on the hybrid recording medium.

Moreover, the hybrid recording medium can also be used in an information recording and reproduction apparatus supporting the conventional DVD+RW disk.

As described above, according to an information recording medium formed of a pre-stamped unrewritable recorded region and a recordable (rewritable) unrecorded region according to the present invention, writing to the recorded region can be inhibited.

Further, according to an information reproduction apparatus according to the present invention, information can be reproduced normally from such an information recording medium.

Further, according to an information recording apparatus and method according to the present invention, information can be recorded normally on such an information recording medium.

The present invention is not limited to the specifically disclosed embodiments, but variations and modifications may be made without departing from the scope of the present invention.

The present application is based on Japanese priority application No. 2002-173905 filed on Jun. 14, 2002, the entire contents of which are hereby incorporated by reference.

What is claimed is:

1. An information recording medium, comprising:
a pre-stamped region formed by pre-stamping a region from a start of a data region of the information recording medium, said pre-stamped region recording information indicating that the information recording medium is a hybrid recording medium formed of a recorded region and an unrecorded region and information indicating that a sector in said pre-stamped region is pre-stamped, the information recording medium being formed based on a recordable recording medium.

2. The information recording medium as claimed in claim 1, wherein lead-in information corresponding to data of said pre-stamped region is recorded, the lead-in information having at least part thereof prerecorded.

3. The information recording medium as claimed in claim 2, wherein temporary lead-out information is recorded subsequent to a data part of the information recording medium.

4. An information reproduction apparatus comprising:
a part that, in the case of detecting from an information recording medium identifier information indicating that the information recording medium is a hybrid recording medium formed of a recorded region and an unrecorded region, recognizes that the information recording medium is the hybrid recording medium and authorizes data reproduction from the information recording medium,
wherein the information recording medium comprises a pre-stamped region formed by pre-stamping a region from a start of a data region of the information recording medium, the pre-stamped region recording the identifier information and information indicating that a sector in the pre-stamped region is pre-stamped, the information recording medium recording lead-in information corresponding to data of the pre-stamped region, the lead-in information having at least part thereof prerecorded, the information recording medium being formed based on a recordable recording medium.

5. An apparatus for reproducing information from an information recording medium, the apparatus comprising:
a determination part that determines whether the information recording medium is a hybrid recording medium formed of a recorded region and a recordable unrecorded region; and
an authorization part that authorizes data reproduction from the information recording medium when said determination part determines that the information recording medium is the hybrid recording medium.

6. The apparatus as claimed in claim 5, wherein said determination part determines that the information recording medium is the hybrid recording medium when said determination part detects identifier information from the information recording medium, the identifier information indicating that the information recording medium is the hybrid recording medium.

7. The apparatus as claimed in claim 6, wherein the identifier information is recorded in a pre-stamped region of the information recording medium.

8. An information recording apparatus, comprising:
a part that, in the case of detecting from an information recording medium identifier information indicating that the information recording medium is a hybrid recording medium formed of a recorded region and an unrecorded region, recognizes that the information recording medium is the hybrid recording medium, and when a command to perform writing to a sector in a pre-stamped region of the information recording medium is issued, reports to an issuer of the command that the writing to the sector in the pre-stamped region is prohibited and inhibits the writing to the information recording medium,
wherein the pre-stamped region of the information recording medium is formed by pre-stamping a region from a start of a data region of the information recording medium, the pre-stamped region recording the identifier information and information indicating that the sector in the pre-stamped region is pre-stamped, the information recording medium recording lead-in information corresponding to data of said pre-stamped region, the lead-in information having at least part thereof prerecorded, the information recording medium being formed based on a recordable recording medium.

9. An apparatus for recording information on an information recording medium, the apparatus comprising:
a determination part that determines whether the information recording medium is a hybrid recording medium formed of a recorded region and a recordable unrecorded region; and
a writing inhibition part that, when said determination part determines that the information recording medium is the hybrid recording medium, inhibits writing to a sector of a pre-stamped region of the information recording medium in response to a command to perform the writing to the sector of the pre-stamped region, the writing inhibition part reporting to an issuer of the command that the writing to the sector of the pre-stamped region is prohibited.

10. The apparatus as claimed in claim 9, wherein said determination part determines that the information recording medium is the hybrid recording medium when said determination part detects identifier information from the information recording medium, the identifier information indicating that the information recording medium is the hybrid recording medium.

11. The apparatus as claimed in claim 10, wherein the identifier information is recorded in the pre-stamped region of the information recording medium.

12. An information reproduction apparatus, comprising:
a part that, when an information recording medium formed of an unrecorded region and a recorded region formed by pre-stamping a region from a data region of the information recording medium is loaded, determines the presence or absence of a lead-in region of the information recording medium, determines the presence or absence of a data region in the absence of the lead-in region, and authorizes data reading from the information recording medium when data is recorded in the data region, the information recording medium being formed based on a recordable recording medium.

13. An apparatus for reproducing information from an information recording medium, the apparatus comprising:
a determination part that determines the presence or absence of a lead-in region on the information recording medium, determines the presence or absence of a data region in the absence of the lead-in region, and determines whether data is recorded in the data region when the presence of the data region is determined; and
an authorization part that authorizes data reading from the information recording medium when said determination part determines that the data is recorded in the data region.

14. An information recording apparatus, comprising:
a part that, when an information recording medium formed of an unrecorded region and a recorded region formed by pre-stamping a region from a data region of the information recording medium is loaded, determines the presence or absence of a lead-in region of the information recording medium, and records data on the information recording medium based on a write enable command received from a host apparatus in the absence of the lead-in region, the information recording medium being formed based on a recordable recording medium.

15. An apparatus for recording information on an information recording medium, the apparatus comprising:
a determination part that determines the presence or absence of a lead-in region on the information recording medium; and
a recording part that records data on the information recording medium based on a write enable command in the absence of the lead-in region.

16. An information recording method comprising the steps of:
(a) issuing a write enable command;
(b) recording information on an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating that a sector in the pre-stamped region is pre-stamped, the information recording medium being formed based on a recordable recording medium; and
(c) recording a lead-in region and a lead-out region on the information recording medium.

17. A program for causing a computer to execute an information recording method, the information recording method comprising the steps of:
(a) issuing a write enable command;
(b) recording information on an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating that a sector in the pre-stamped region is pre-stamped, the information recording medium being formed based on a recordable recording medium; and
(c) recording a lead-in region and a lead-out region on the information recording medium.

18. A computer-readable recording medium storing a program for causing a computer to execute an information recording method, the information recording method comprising the steps of:
(a) issuing a write enable command;
(b) recording information on an information recording medium including a pre-stamped region formed by pre-stamping a region from a start of a data region of the information recording medium, the pre-stamped region recording information indicating that the information recording medium is a hybrid recording medium formed of a recorded region and an unrecorded region and information indicating that a sector in the pre-stamped region is pre-stamped, the information recording medium being formed based on a recordable recording medium; and
(c) recording a lead-in region and a lead-out region on the information recording medium.
